(19) United States
(12) Patent Application Publication
(10) Pub. No.: US 2014/0100498 A1
(43) Pub. Date: Apr. 10, 2014

(54) UNKNOWN

(71) Applicant: Klaus RICHTER, Langenselbold (DE)

(72) Inventor: Klaus RICHTER, Langenselbold (DE)

(21) Appl. No.: 14/047,276

(22) Filed: Oct. 7, 2013

(30) Foreign Application Priority Data
Oct. 5, 2012 (DE) 20 2012 103 831.5

(51) Int. Cl. A61H 23/00

(52) U.S. Cl. CPC A61H 23/00
USPC 601/46

(57) ABSTRACT

Device (46) for activating the muscles of the mouth and/or lips, comprising a mouthpiece (48) which can be inserted between the lips and the teeth of a user. To simplify the use of the device and improve its effect, the mouthpiece (48) is configured as an active vibrator (56) generating mechanical vibrations.

The invention pertains to a device for activating the muscles of the mouth and/or lips, comprising a mouthpiece between the lips and the teeth of a user.

A device of the known kind is familiar from DE 90 01 001 U1. The known device comprises a mouthpiece inserted between the lips and the teeth of the user, being supported against the inside of the lips and able to be activated by a pulling body that protrudes from the mouth. The mouthpiece is configured so that the annular muscles of the mouth can be supported against the front of the mouthpiece. When the pulling body is activated, the muscles of the mouth and lips can thus be trained and strengthened. However, this device necessarily requires an active behavior of the user to activate the annular muscles of the mouth.

A device for training of the orofacial muscles is known from DE 198 31 741 A1. The device comprises a vestibular shield with a part arranged on its front side, the part being a lip wedge projecting from the front side. The elastic lip wedge is supposed to provide a constant stimulus to the lip muscles, wherein the annular muscles of the lips automatically enclose the wedge and constantly compress it thanks to a high elasticity. This is supposed to activate the adjacent muscles, heightening the tone of the cheek muscles and the entire chewing muscles. In this device as well, the user must actively engage the lip muscles to accomplish their training.

Furthermore, so-called vestibular plates are known from the prior art, such as DE 39 15 505 C2. these comprise a shield-like part, having a central extension piece molded on it, from which a ring can be attached. The shield-like part has the shape of a curved strip with rounded ends and is basically divided into three segments, wherein a middle segment carries the extension piece and the wings adjoining the middle piece on both sides. Vestibular plates are used as early treatment aids preferably in patients with milk teeth or in the early mixed dentition period.

DE 203 10 769 pertains to an exercise device for the tongue and the muscles of the orofacial region to achieve a stable posture of the tongue against the palate, consisting of a lip shield with at least one perforation and a vestibular projecting and preferably elastic chamber. The known exercise device is distinguished in that the elastic chamber can be reversibly joined by form fit and force fit to the lip shield, in which position it is in communication with the interocclusal space and thus it supports the forming and displaying of an interocclusal underpressure.

DE 10 2005 058 641 A1 pertains to an apparatus for training the closure of the mouth. The apparatus comprises a shield and a flexible projection which can be enclosed by the person's lips, the projection being sheetlike in shape.

10 2008 016 885 B4 pertains to a tongue, lip and face trainer for people, especially children, with a shield and a flexible suction element. The tongue, lip and face trainer is characterized in that means are provided for stimulation and localization of the tip of the tongue at a medically advantageous site, wherein the suction element is sheetlike, wherein the distance of the means of stimulation and localization of the tip of the tongue from the shield is such that these means when the tongue, lip and face trainer is used properly are located at the level of the rugae, wherein the means for stimulation and localization of the tip of the tongue comprise a depression or a hole situated on the side of the suction element facing the tongue when the trainer is used correctly.

Furthermore, a device for training the muscles of the lips and face is known from DE 20 2008 007 422 U1, with a curved mouthpiece that is placed preferably between the lips and the teeth. The device is characterized in that a relatively soft and physically tolerated material is used, which produces a mechanical stress against the upper and/or lower lips, in order to promote the buildup of the muscles of the facial physiognomy.

Based on the foregoing, the problem of the present invention is to modify a device of the kind mentioned above so that the activation of the muscles of the mouth and/or lips does not require an active exertion by the user.

The problem is solved according to the invention in that the mouthpiece is configured as an active vibrator generating mechanical vibrations.

As compared to the prior art, the invention is characterized in that active exertions are not required by the user of the device. The activation of the muscles of the mouth and/or lips, especially the muscles of the mouth ring (M. orbicularis oris), by mechanical vibration serves to reduce lip wrinkles and tighten the skin in the region of the lips.

According to one preferred embodiment, the mouthpiece comprises an active vibration means or can be coupled to such a means.

In an especially preferred embodiment, the mouthpiece comprises the active vibration means as an integrated component. The mouthpiece can also have an extension piece projecting radially from a front side of the mouthpiece lying against the inside of the lips, the vibration means being integrated into the extension piece or it can be removably accommodated therein.

According to one preferred embodiment, the extension piece is configured as a hollow cylindrical stump, and the active vibration means can be inserted in the hollow cylindrical stump, such as a vibration motor.

The mouthpiece and the hollow cylindrical stump are fashioned as a single molded piece of plastic, such as silicone. Preferably, the hollow cylindrical stump has a diameter such that the preferably cylindrical vibration motor is fixed in the hollow cylindrical stump by the natural tension of the plastic, such as silicone.

Furthermore, it is provided that support elements for the hollow cylindrical stump extend from the front side of the mouthpiece. The support elements are preferably configured as an integral part of the mouthpiece.

A vibration motor is preferably provided as the vibration means, being situated in a cylindrical housing. The housing preferably accommodates the vibration motor, the battery, as well as a switch element for turning on the vibration motor. The vibration means can vibrate with a frequency in the range of 5 Hz to 250 Hz, preferably 100 Hz to 250 Hz. In preferred embodiment, the vibration frequency is adjustable, preferably step I=140 Hz, step II=180 Hz and step III=210 Hz.

The vibration motor can be coupled by mechanical coupling elements such as spirals or netting to the mouthpiece in order to transmit the vibrations into the shield. The coupling means are integrated in the mouthpiece, such as by being molded in it.

A battery as well as a switch element are integrated in the extension piece as the power supply of the vibration motor and for turning it on and off.

Another preferred embodiment is characterized in that the front side has eminences such as knobs, which by vibrating activate the particular portions of the muscles.

In order to assure an easy production of the device and an individual adaptation to different oral vestibules, the device is made of silicone. The silicone can have a Shore hardness SH in the range of 10≦SH≦50, preferably SH=20.

Thanks to being made as a molded plastic part, the device can be ready packaged. Neither a jaw impression nor a bite molding is needed for its functional capability. Since the mouthpiece is made of silicone, it can be trimmed individually by the user. Therefore, no individual adaptation is needed by a dentist or an orthodontist. A soft silicone with a Shore hardness in the range of 10≦SH≦50, preferably SH=20, is distinguished by an especially effective transmission of vibrational oscillations, while harder material would have a negative impact on the vibration effect.

The silicone used is medical grad, guaranteeing a safe use in the mouth. This can be cleaned under running water by the adding of cleaning agents such as mild soap solution or lemon juice. Since the lip trainer of the invention is not subjected to any chewing force, there is no fear of abrasion.

The lip trainer of the invention is ready packaged and corresponds in its dimension to the predetermined shape of an oral vestibule, while recesses are provided in the area of the extension piece for the upper and lower lip frenulum.

In an alternative embodiment, the mechanical vibrations are transmitted to the mouthpiece across a wire spiral or netting. The vibrator is energized by a built-in battery. The battery is located in the extension piece projecting from the mouth and is connected to an on/off switch. All technical parts are integrated components of the lip trainer and arranged outside the oral vestibule and cannot come into contact with the oral or lip mucosa.

Another preferred embodiment is characterized in that the vibration means, such as a vibration motor, can be coupled to an extension piece projecting radially from the front side of the mouthpiece.

Further details, benefits and features of the invention will emerge not only from the claims and the features found therein—in themselves and/or in combination—but also from the following description of a preferred sample embodiment, shown in the drawings.

There are shown:

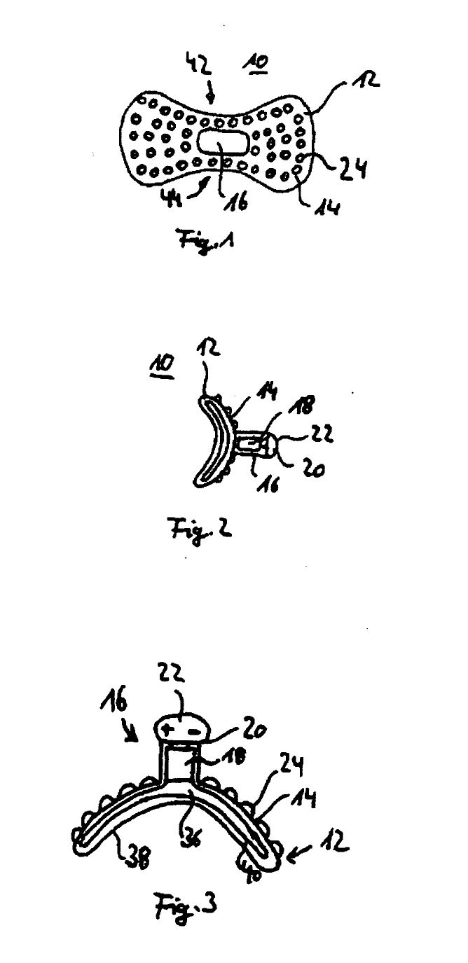

FIG. 1, a front view of a first embodiment of the device of the invention,

FIG. 2, a top view of the device of the invention,

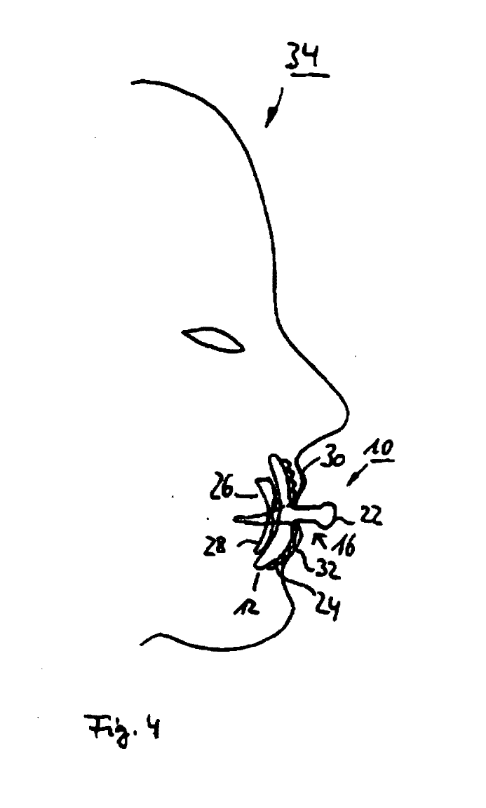

FIG. 3, an enlarged representation of the top view of FIG. 2,

FIG. 4, a device in use by a user between front teeth and inside of the lips,

FIG. 5, a perspective view of a second embodiment of the device of the invention,

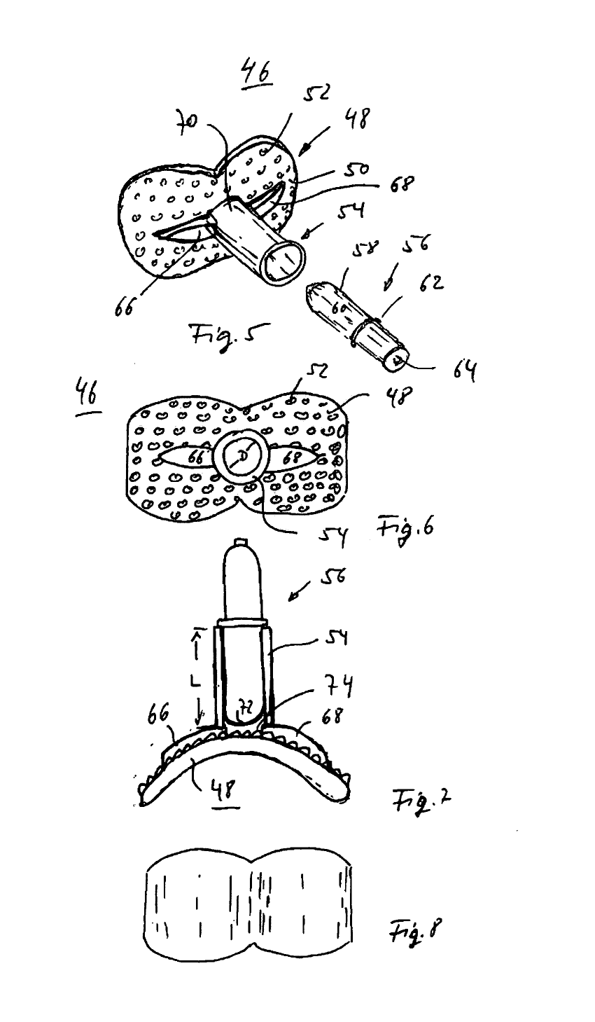

FIG. 6, a front view of the device of FIG. 5,

FIG. 7, a side view of the device of FIG. 5, partly sectioned, with the vibration motor inserted, and

FIG. 8, a rear view of the device of FIG. 5.

FIGS. 1 to 3 show a view of a device 10 for activation of the mouth and/or lip muscles. The device 10, hereinafter called a lip trainer, comprises a mouthpiece in the form of a shield 12 with an extension piece 16 projecting radially from a convex front side 14, in which a vibration motor 18 with a battery 20 and on/off switch element 22 is arranged.

The vibration motor 18 is coupled by the extension piece 16 to the vestibular shield 12 in order to transmit vibrations into the shield 12. The convex front side 14 of the vestibular shield 12 has eminences such as knobs 24, by which the vibration action of the vestibular shield 12 on the mouth and/or lip muscles is transmitted.

FIG. 4 shows the lip trainer 12 in use between front teeth 26, 28 and upper lip 30 and lower lip 32 of a user 34.

The lip trainer 10 serves to reduce lip wrinkles and to tighten the skin in the region of the lips 30, 32 by activation of the mouth ring muscle (M. orbicularis oris) by mechanical vibration. The mechanical vibration is generated by the vibration motor 18, which is permanently installed in the lip trainer 10 or can be coupled to it. Such a lip trainer is distinguished from known lip trainers in that an active exertion by the user of the lip trainer 10 is not required.

Thanks to the eminences/depressions in the form of knobs 24 that are integrated on the front side 14 of the shield 12, passive elements are provided that activate the respective portions of the muscles by the vibration.

Hormones are produced by the vibration and break down the fatty tissue. Furthermore, creatine is produced, which in turn exerts an intensified influence on the firmness of the skin. Thanks to the mechanical vibration, a reduction of fat in the skin in the region of the mouth ring muscle is achieved.

The vibration motor 18 is preferably integrated in the extension piece 16 or coupled to it and connected directly or indirectly to the shield 12, in order to transmit vibrations of the vibration motor 18 to the shield 16. Coupling elements 36 in the form of a wire netting or a wire spiral are provided for the transmittal of the vibrations. These start at the vibration motor 18 and extend into the wings 38, 40 of the shield 12 to optimally transmit the vibrations of the vibration motor 18 to the convex front side 14.

The vibration motor 18 generates a preferably harmonic oscillation with a frequency VF in the range of preferably 5 Hz≦FV≦250 Hz and can be adjusted in stages of FV=140 Hz, FV=180 Hz, and FV=210 Hz.

The vestibular shield 12 as well as the extension piece 16 with integrated vibration motor 18 are made as a single piece, preferably from a plastic like silicone. This has a Shore hardness in the range of 10≦SH≦50, preferably SH=20, in order to achieve an optimal transmission of the vibrations of the vibration motor 18 to the vestibular shield 12.

FIG. 1 further shows that the vestibular shield 12 has recesses 42, 44 in the region of the upper and lower lip frenulum. Moreover, the shield 12 has a width that reaches to the first premolars. The arrangement of the vibration motor 18, the battery 20 and the switch element 22 in the extension piece 16 ensures that no technical parts come into contact with mouth or lip mucosa.

All technical parts are integrated in the plastic molded piece during the manufacture of the device.

FIG. 5 shows in perspective view a second especially preferred embodiment of a device 46 for activation of the mouth and/or lip muscles 30, 32, with a mouthpiece 48 which can be inserted between the lips 30, 32 and the teeth 26, 28 of a user 34, being configured as a shield-like plate, having eminences such as knobs 52 on its front side 50. In the embodiment of FIG. 5, an extension piece 54 extends from the front side 50 of the mouthpiece 48, in which the vibration means 56 is removably accommodated in the form of a vibration motor 60 arranged in a preferably cylindrical housing 58.

The extension piece 54 is designed as a hollow cylindrical stump, such as a piece of hose, made of plastic such as silicone, and the cylindrical housing with the vibration motor 60 arranged in it can be inserted into the hollow cylindrical stump. For further fixation of the vibration motor 56, the housing can have an encircling bulge 62, which is enclosed at the edge by the hollow cylindrical stump 54. A switch element 64 is provided in the housing 58 at the front in order to turn on the vibration motor 60.

The extension piece 54 is integrally connected to the mouthpiece 48, preferably being a single molded piece.

Furthermore, coupling or supporting elements 66, 68 extend onto or from the front side 50 of the mouthpiece 48, being connected to an encircling edge 70 of the hollow cylindrical stump 54, in order to support the extension piece and couple vibrations of the vibration means into the mouthpiece 48.

FIG. 6 shows a top view of the device 46 with front side, from which knobs 32, the support elements 66, 68, and the hollow cylindrical stump 54 extend.

FIG. 7 shows a side view, where the vibration means 56 is accommodated in the hollow cylindrical stump 54. The hollow cylindrical stump 54 has a diameter D and a length L corresponding essentially to a diameter D of the vibration means 56 and a length L of the active part, so that a front section 72 of the vibration means 56 extends as far as the front side 50 of the mouthpiece 48, so that the vibrations of the vibration means 56 are transmitted directly to the mouthpiece 48. Furthermore, the vibrations are coupled into the mouthpiece 48 via the encircling lateral surface of the hollow cylindrical stump and the support elements 66, 68.

FIG. 8 shows a rear view of the device 46, having a surface that is smooth in shape.

1. Device (10, 46) for activating the muscles of the mouth and/or lips (30, 32), comprising a mouthpiece (12, 48) which can be inserted between the lips (30, 32) and the teeth (26, 28) of a user (34),
characterized in that
the mouthpiece (12, 48) is configured as an active vibrator generating mechanical vibrations.

2. Device according to claim 1,
characterized in that
the mouthpiece (12, 48) comprises an active vibration means (18, 56) or can be coupled to such a means.

3. Device according to claim 2,
characterized in that
the active vibration means (18) is configured as an integrated component of the mouthpiece (12).

4. Device according to claim 2,
characterized in that
the active vibration means (18, 56) is integrated into or can be removably accommodated in an extension piece (16, 54) projecting radially from a front side (14, 50) of the mouthpiece (48) lying against the inside of the lips.

5. Device according to claim 4,
characterized in that
the extension piece (54) is configured as a hollow cylindrical stump, such as a piece of hose, and the active vibration means (56) can be inserted in the stump (54), such as a vibration motor.

6. Device according to claim 5,
characterized in that
the mouthpiece (48) and the hollow cylindrical stump (54) are fashioned as a single molded piece of plastic, such as silicone.

7. Device according to claim 4,
characterized in that
coupling and/or support elements (66, 8) extend from the front side (50) of the mouthpiece (48) and are joined to a peripheral edge (20) of the extension piece (54).

8. Device according to claim 2,
characterized in that
the active vibration means (18, 56) can vibrate with a frequency (FV) in the range of 5≦FV≦220 Hz, preferably FV=140 Hz, FV=180 Hz, or FV=210 Hz.

9. Device according to claim 2,
characterized in that
the active vibration means (56) is configured as a vibration motor which situated in a cylindrical housing (58).

10. Device according to claim 2,
characterized in that
the active vibration means (18) is coupled by coupling elements (36) to the mouthpiece (12), the coupling elements (36) being fashioned preferably as a wire spiral or wire netting and integrated in the mouthpiece (12), such as by being molded in it.

11. Device according to claim 4,
characterized in that
a power supply such as a battery and an on/off switch element are integrated in the mouthpiece (12) and/or the extension piece (16).

12. Device according to claim 1,
characterized in that
the mouthpiece (12, 48) is configured as a shield-like plate (12, 48) which can be inserted between the lips (30, 32) and the teeth (26, 28) of a user (24) and/or one front side (14, 50) of the mouthpiece (12, 48) has depressions and/or eminences such as knobs (24, 52).

13. Device according to claim 12,
characterized in that
the shield-like plate (12, 48) and/or the extension piece (16, 54) is made of a plastic like silicone.

14. Device according to claim 13,
characterized in that
the silicone used has a Shore hardness (SH) in the range of 10≦SH≦50, preferably SH=20.
